(19) United States
(12) Patent Application Publication
(10) Pub. No.: US 2025/0007224 A1
(43) Pub. Date: Jan. 2, 2025

(54) THROUGH-APERTURE ELECTRICAL CONNECTOR

(71) Applicant: Aptiv Technologies AG, Schaffhausen (CH)

(72) Inventors: Nicholas Durse, Youngstown, OH (US); Patrick Reedy, Youngstown, OH (US); William Lovitz, Niles, OH (US); Michael Mellott, Youngstown, OH (US); Eric Shasteen, Salem, OH (US)

(21) Appl. No.: 18/753,313

(22) Filed: Jun. 25, 2024

Related U.S. Application Data
(60) Provisional application No. 63/523,964, filed on Jun. 29, 2023.
(60) Provisional application No. 63/524,127, filed on Jun. 29, 2023.
(60) Provisional application No. 63/544,691, filed on Oct. 18, 2023.

(51) Int. Cl. H01R 13/74

(52) U.S. Cl. CPC H01R 13/748; H01R 13/746

(57) ABSTRACT

Electrical connectors coupleable through an aperture in a substrate are described. According to various embodiments, an electrical connector includes an upper mounting unit and a lower mounting unit. The upper mounting unit includes a first surface that engages with a first planar surface of the substrate, and a second surface that engages with a second surface of the substrate arranged substantially perpendicular to the first planar surface. The lower mounting unit is coupleable to the upper mounting unit through the aperture and engages with a third planar surface of the substrate opposed to the first planar surface of the substrate to secure the electrical connector in the aperture.

### CROSS-REFERENCE TO RELATED APPLICATIONS

This application claims the benefit of and priority to U.S. provisional application 63/523,964 titled “Header Connector Assembly” filed Jun. 29, 2023, U.S. provisional application 63/524,127 titled “Header Connector Assembly” filed Jun. 29, 2023, and U.S. provisional application 63/544,691, titled “Through-Aperture Electrical Connector” filed Oct. 18, 2023, the entire contents of which are incorporated by reference herein.

### BACKGROUND

Electrical connectors are commonly used in many commercial, industrial, and military applications to implement power, signal, and data systems. In some applications, electrical connectors may be used to establish electrical connections through a physical barrier, such as a through an aperture formed in a substrate. As one specific example, a vehicle battery, battery system, or other component may be housed in an enclosure, and electrical connectors may be used to facilitate electrical connection to the battery through apertures formed in the enclosure. A need exists for improvements in through-aperture electrical connectors that are relatively easy to install and/or resistant to unintended decoupling during vehicle operation, manufacturing, or distribution processes.

### SUMMARY

Improvements in through-aperture electrical connectors are described. According to one example, an electrical connector is configured to establish an electrical connection through an aperture formed in a substrate. The electrical connector includes an upper mounting unit that includes a first surface in mechanical connection with a first planar surface of the substrate through which the aperture is defined, and a second surface different than the first surface in mechanical connection with a second planar surface of the substrate that is substantially perpendicular to the first planar surface of the substrate. The electrical connector further includes a lower mounting unit configured to be coupled to the upper mounting unit and secured within the aperture via mechanical connection with a third planar surface of the substrate, wherein the third planar surface of the substrate is opposed to the first planar surface of the substrate. In some examples, the second planar surface of the substrate is a vertical surface of a flange formed in the substrate. In some examples, the upper mounting unit includes a platform and a cylinder, and the lower mounting unit is coupleable to the upper mounting unit via the cylinder through the aperture, and engages with the third planar surface to secure the connector in the aperture. In other examples, the lower mounting unit includes the platform, and includes a ledge that engages with the third planar surface, and is coupleable to the upper mounting unit by a bolt secured to a threaded post on the lower mounting unit platform.

According to another example, a method is described. The method includes arranging an upper mounting unit of an electrical connector in a staged position in an aperture in a substrate. Arranging the upper mounting unit comprises engaging a first surface of the upper mounting unit with a first planar surface of the substrate through which the aperture is defined, and engaging a second planar surface of the substrate arranged substantially perpendicular to the first planar surface of the substrate. The method further includes coupling a lower mounting unit of the electrical connector to the upper mounting unit to engage a third surface of the substrate opposed to the first planar surface of the substrate to secure the electrical connector in the aperture. In some examples, coupling the lower mounting unit to the upper mounting unit comprises twisting the lower mounting unit onto a cylinder of the upper mounting unit. In other examples, coupling the lower mounting unit to the upper mounting unit comprises securing a snap ring onto a cylinder of the upper mounting unit. In other examples, coupling the upper lower mounting unit and the lower mounting unit together in the aperture comprises securing the connector using a single bolt.

### DESCRIPTION OF THE DRAWINGS

FIG. 1 depicts an isometric view of an electrical connector according to one or more embodiments.

FIG. 2 depicts an exploded view showing components of an electrical connector according to one or more embodiments.

FIG. 3A depicts a top-down view of a lower mounting unit according to some embodiments.

FIG. 3B depicts a side view of an electrical connector being secured according to one or more embodiments.

FIGS. 4A and 4B depict exploded views of an electrical connector according to one or more embodiments.

FIG. 5 depicts a top-down view of an electrical connector according to one or more embodiments.

FIG. 6A depicts a partial cross-sectional view of an electrical connector configured to be secured through a substrate according to one or more embodiments.

FIG. 6B depicts a cross-sectional view of an electrical connector configured to be secured through a substrate with a raised ridge according to one or more embodiments.

FIG. 7A depicts side a side view of an electrical connector according to some embodiments.

FIG. 7B depicts a cross-sectional view of an electrical connector according to some embodiments.

FIG. 7C depicts an exploded view of an electrical connector according to some embodiments.

FIG. 7D depicts a perspective view of an electrical connector according to some embodiments.

FIG. 8 depicts an isometric view of an electrical connector that includes an adaptor plate according to some embodiments.

FIG. 9 depicts an exploded view showing components of an electrical connector that includes an adaptor plate according to one or more embodiments.

FIGS. 10A and 10B depict exploded views of an electrical connector that includes an adaptor plate according to one or more embodiments.

FIG. 11 depicts a top-down view of an electrical connector that includes an adaptor plate according to some embodiments.

FIG. 12A depicts a cross-sectional view of an electrical connector that includes an adaptor plate according to some embodiments.

FIG. 12B depicts a cross-sectional view of an electrical connector that includes an adaptor plate according to some embodiments.

FIG. 13 depicts an isometric view of an electrical connector that includes an integrated adaptor plate according to some embodiments.

FIGS. 14A and 14B depict an exploded views of an electrical connector that includes an integrated adaptor plate according to some embodiments.

FIG. 15 is a top-down view of an electrical connector that includes an integrated adaptor plate according to some embodiments.

FIG. 16A depicts a cross-sectional view of an electrical connector that includes an integrated adaptor plate according to some embodiments.

FIG. 16B depicts a cross-sectional view of an electrical connector that includes an integrated adaptor plate according to some embodiments.

FIG. 17 is a flow diagram that shows a method of securing an electrical connector according to some embodiments.

### DETAILED DESCRIPTION

Various embodiments of through-hole electrical connectors are described. According to these embodiments, through-aperture electrical connectors are described that reliably secure an electrical connection through a flanged aperture in a substrate. According to these embodiments, the through-hole connector includes an upper mounting unit and a lower mounting unit that work together to enable an electrical connection through the substrate. The upper mounting unit includes a first surface in mechanical connection with a first planar surface of the substrate, and a second surface in mechanical connection with a second planar surface of the substrate substantially perpendicular to the first planar surface of the substrate. The upper mounting unit is configured to be coupled to the lower mounting unit and secured within the aperture via mechanical connection with a third planar surface of the substrate opposed to the first planar surface of the substrate.

The various embodiments of through-aperture electrical connectors described herein may offer advantages over other known means for forming electrical connections through a substrate. For example, the various embodiments each include features enabling electrical connections to be established through a substrate via a flanged aperture in the substrate that are easier to install and/or more resilient to unintended disconnection in comparison to known electrical connectors. For example, some embodiments described herein enable a human or robotic operator to secure the connector within the aperture without bolts, while other embodiments enable an operator to secure the connector using only a single bolt.

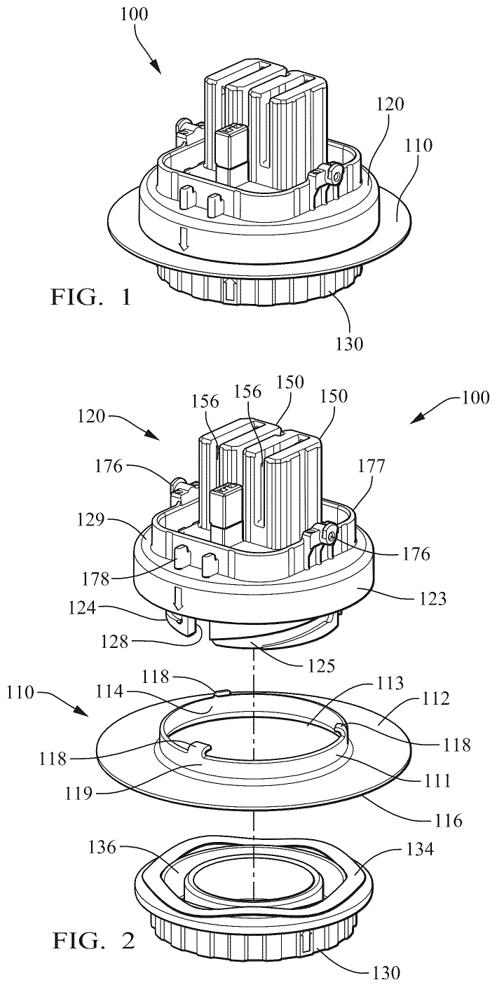

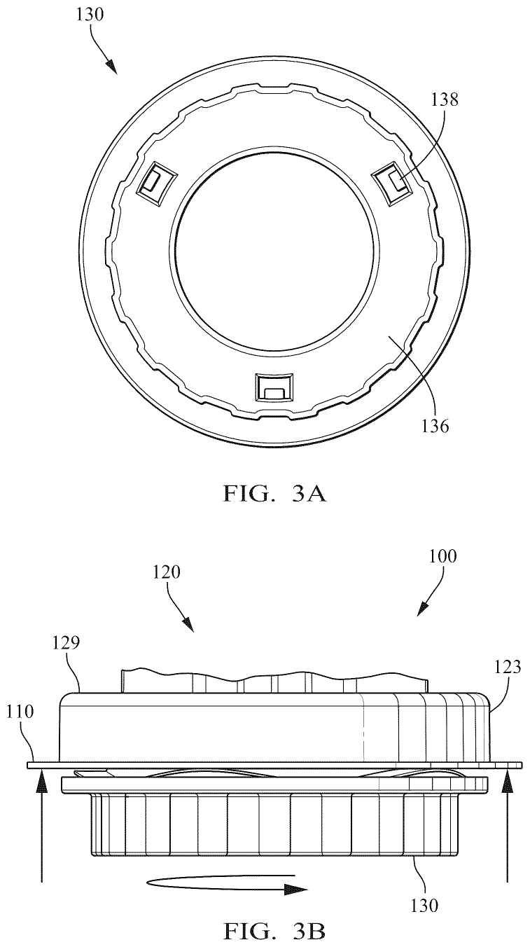

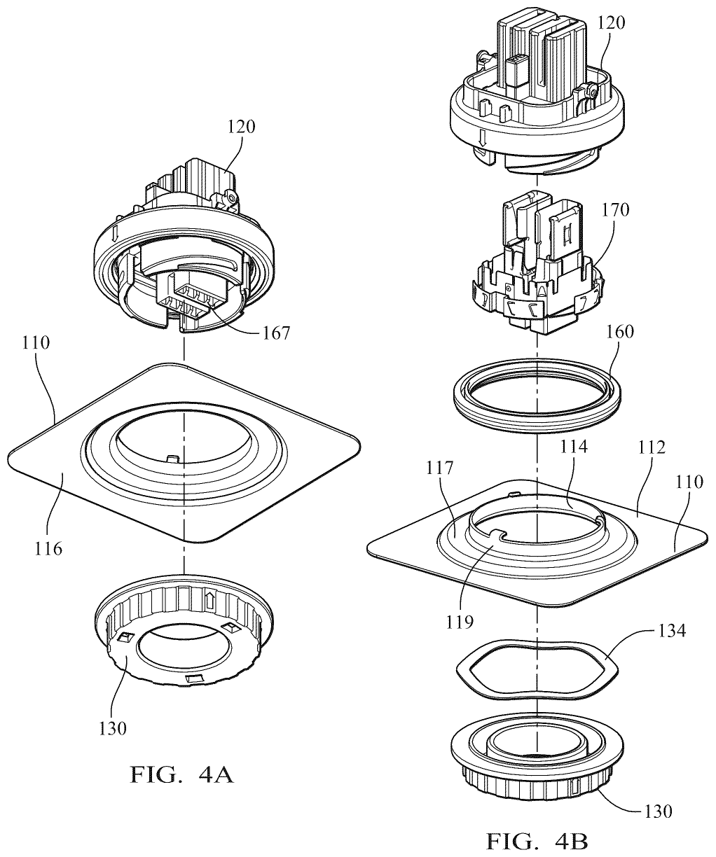

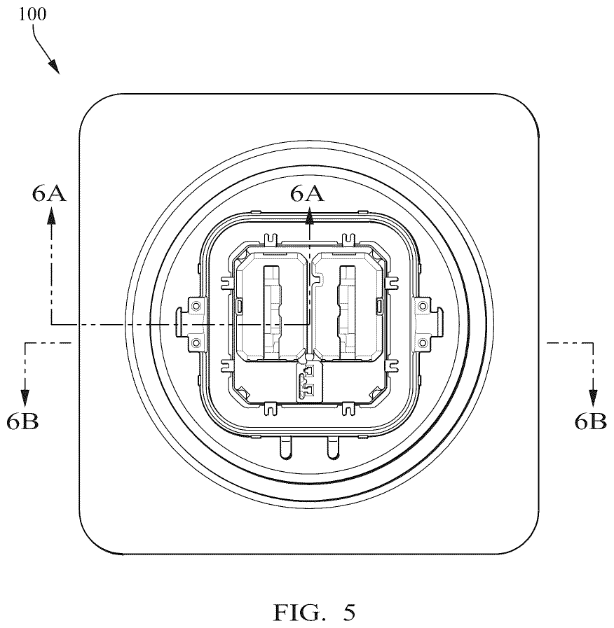

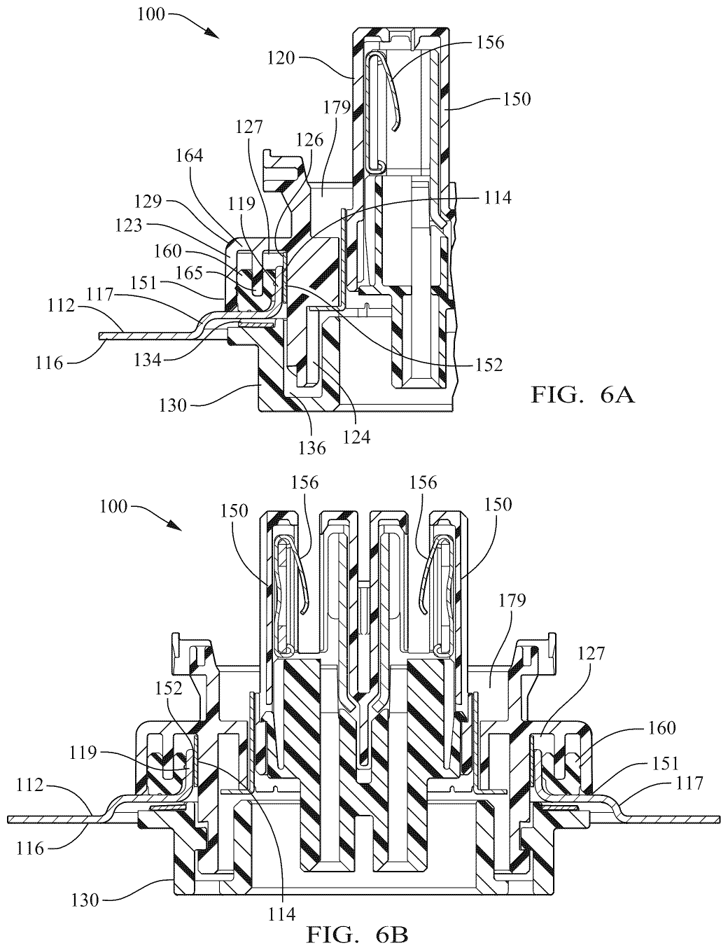

FIG. 1 depicts an isometric view of an electrical connector 100 according to some embodiments. According to the embodiment of FIG. 1, connector 100 includes an upper mounting unit 120 and a lower mounting unit 130 that is a twist-on cap according to some embodiments. In the example of FIG. 1, connector 100 is arranged in a locked position to establish an electrical connection through an aperture 113 (shown in FIG. 2) in a substrate 110 according to some embodiments. FIG. 2 depicts an exploded view of electrical connector 100, as well as substrate 110 that includes an aperture 113 according to some embodiments. FIG. 3A depicts a top-down view of a lower mounting unit 130 according to some embodiments. FIG. 3B depicts a side view of lower mounting unit 130 being secured to upper mounting unit 120 through aperture 113 with a twisting motion according to some embodiments. FIGS. 4A and 4B depict alternate exploded views of connector 100 according to some embodiments. FIG. 5 depicts a top-down view of connector 100 according to some embodiments. FIGS. 6A and 6B depict respective partial cross-sectional and cross-sectional views of connector 100 according to some embodiments.

Substrate 110 may be, for example, a cover, a wall, or other surface of an enclosure configured to house one or more electrical components within the enclosure. For example, substrate 110 may be a surface of a battery box configured to house one or more components of a vehicle electrical system, such as one or more battery cells of the vehicle electrical system. In some examples, the substrate 110 is formed of 1 mm thick sheet metal. Connector 100 may be configured to enable electrical connection from one side of the substrate 110 to another side of the substrate 110 through the aperture 113.

In some examples, substrate 110 may be formed of a suitable material to operate as an enclosure to house one or more vehicle electrical components, such as a metal or plastic substrate. In some examples, substrate 110 is part of a sheet metal enclosure that serves to house one or more battery or other components of a vehicle, such as an electric, hybrid, and/or gas-powered vehicle.

As shown in FIG. 2, substrate 110 includes a flange 111 formed in substrate 110 surrounding an aperture 113, which in the example of FIG. 2 has an annular shape. As shown in FIG. 2, substrate 110 has a first planar surface 112 through which aperture 113 is formed, and flange 111 includes a second planar surface 114 (an inner surface of flange 111) arranged perpendicular to the first planar surface and surrounding aperture 113. Flange 111 further includes an outer planar surface 119.

Connector 100 is configured to be secured in aperture 113 to enable an electrical connection through aperture 113 by securing lower mounting unit 130 to upper mounting unit 120. As shown in FIG. 2, upper mounting unit 120 includes a platform 129 supported by a rim 123, and towers 150 presented on the platform 129. Towers 150 may support one or more electrical terminals 156, configured to receive corresponding terminals of a connector associated with a vehicle electrical system, such as a vehicle wiring harness. For example, towers 150 may serve as a cover for a terminal support unit 170 depicted in FIG. 4B configured to support one or more electrical terminals 156 for connection through towers 150. As shown in FIG. 4A, the terminal support unit 170 may further include a lower connector 167, configured to support electrical connection from the underside of upper mounting unit 120, for example to connect with an electrical component housed within an enclosure comprising substrate 110, such as one or more batteries or battery components of a vehicle electrical system, according to one or more embodiments.

In some examples, upper mounting unit 120, including platform 129 and towers 150 is configured to interface with a corresponding electrical connector (not shown) to establish an electrical connection to other components of a vehicle electrical system, such as a wiring harness of the vehicle. Upper mounting unit 120 may be equipped with one or more features to support a secure electrical connection with a particular electrical connector. For example, platform 129 presents a flange 177, housing lock features 176, and alignment tabs 178. According to these examples, a connector (not shown) may be adapted to interface with flange 177 and alignment tabs 178 to define a seated position of the connector relative to the upper mounting unit 120. The connector may be locked by corresponding connector features that engage with housing lock features 176. At the same time, electrical terminals of the connector may be electrically coupled with corresponding terminals 156 in towers 150. In some examples, upper mounting unit 120 may include a seal track 179 to accommodate a seal (not shown) between a mounted connector (also not shown) and the platform 129.

Upper mounting unit 120 includes one or more features to support alignment of the upper mounting unit 120 within aperture 113. As shown in FIG. 2, upper mounting unit 120 includes a cylinder 124 that extends from a bottom surface of platform 129. Cylinder 124 is sized and shaped to fit within aperture 113 to define a seated position of upper mounting unit 120 in which connector 100 may be secured in position within aperture 113 via lower mounting unit 130.

FIG. 5 is a top-down view of connector 100 according to some embodiments. FIGS. 6A and 6B depict partial cross-sectional and cross-sectional views of connector 100 in a locked position within aperture 113, respectfully. FIG. 6A is a partial cross-sectional view taken along the lines B-B depicted in FIG. 5, while FIG. 6B is a cross-sectional view taken along the lines C-C depicted in FIG. 5.

As shown in FIGS. 6A and 6B, upper mounting unit 120 further includes a flange track 127 at the underside of the upper mounting unit 120 that is configured to accommodate flange 111 to define a seated position of upper mounting unit 120 within aperture 113. As shown in the 6A and 6B examples, the flange track 127 may be an annular track with a diameter that corresponds to a diameter of flange 111. Flange track 127 may have a height and width selected to accommodate a height and width of flange 111, for example such that flange track 127 fits snugly around flange 111 and/or a seal 160 at least partially disposed within the flange track 127.

According to the example depicted in FIG. 2, in an embodiment, upper mounting unit 120 further includes a plurality of slots 128 configured to interface with a plurality of tabs 118 presented in aperture 113 to align upper mounting unit 120 within aperture 113 and define a radial position of upper mounting unit 120 within aperture 113. In the example of FIG. 2, tabs 118 are presented on an upper rim of flange 111, but could instead be arranged elsewhere on an inner surface of flange 111 in other embodiments.

Referring again to the examples of FIGS. 6A and 6B, upper mounting unit 120 further includes a shielding contact 126, for example, within flange track 127. Shielding contact 126 may, for example, be arranged on a second surface 152 of upper mounting unit 120 that engages with the surface 114 of substrate 110 in flange track 127 when connector 100 is secured in aperture 113. Shielding contact 126 may electrically couple substrate 110 to one or more shielding features (not shown) of connector 100 and/or components coupled to connector 100.

Referring to FIGS. 6A and 6B, in some embodiments, upper mounting unit 120 may be adapted to carry a seal 160. According to these examples, upper mounting unit 120 includes a seal track 164 adjacent to the flange track 127 that carries at least part of the seal 160. As shown in the FIG. 6A example, flange track 127 and seal track 164 each carry respective parts of the seal 160. As shown in FIG. 6A, a divider 165 separates the flange track 127 and the seal track 164.

As shown in FIG. 6A, when connector 100 is secured in a locked position in aperture 113, seal 160 engages with the first planar surface 112 of the substrate 110 and the divider 165 as a first sealed surface of the seal 160. As also shown in FIG. 6A, seal 160 engages with flange 111 (e.g., via surface 119) as a second sealed surface of the seal 160. In addition, seal 160 engages with rim 123 as a third sealed surface of the seal 160.

As shown in FIG. 2, lower mounting unit 130 is a twist on cap that includes a cylinder track 136 and a spring 134. Cylinder track 136 is sized, shaped, and arranged to receive cylinder 124 to define a seated position of lower mounting unit 130, and to interface with cylinder 124 to bring upper mounting unit 120 and lower mounting unit 130 together in a twisting motion as depicted in FIG. 3B, in order to lock connector 100 in position within aperture 113, as depicted in FIG. 1. As shown in FIG. 3A, lower mounting unit 130 includes a plurality of cam members 138 in the cylinder track 136. In some examples, lower mounting unit 130 includes three cam members 138, arranged 120 degrees apart in cylinder track 136. Lower mounting unit 130 may include more or fewer cam members 138 in other embodiments.

Connector 100 includes spring 134 in some embodiments. According to these embodiments, spring 134 is a concentric wave spring positioned on a surface of lower mounting unit 130 opposed to substrate 110. In some examples, spring 134 operates to increase a retention force applied to third planar surface 116, and thereby improve a resiliency of connector 100 to unintended decoupling.

As also shown in the example of FIG. 2, upper mounting unit 120 includes a cam track 125 at a surface of cylinder 124. Cam track 125 is configured to, when upper mounting unit 120 is arranged in a seated position with cylinder 124 in aperture 113, define a path of corresponding cam members 138 in cylinder track 136 to bring upper mounting unit 120 and lower mounting unit 130 together into a locked position of connector 100, for example in response to a twisting force applied to mounting unit 130 as depicted in FIG. 3B. An operator rotating lower mounting unit 130 into a locked position relative to upper mounting unit 120 causes lower mounting unit to mechanical engage with the third planar surface 116 of substrate 110 that is opposed to the first planar surface 112, thereby securing electrical connector 100 within aperture 113.

Connector 100 may be mated within aperture 113 when a human or robotic operator positions upper mounting unit 120 in a seated position by inserting cylinder 124 into aperture 113, with slots 128 aligned with tabs 118, and flange track 127 aligned with flange 111. The operator may then secure lower mounting unit 130 to upper mounting unit 120 via cylinder 124 in interaction with cylinder track 136 to secure upper mounting unit 120 within aperture 113 with a twisting motion to lock connector 100 in place in aperture 113, for example as depicted in FIG. 3B.

In some examples, inserting cylinder 124 into aperture 113 such that the flange track 127 receives the flange 111 includes bringing a first surface 151 of the upper mounting unit 120 into engagement with a first planar surface 112 of the substrate 110 and bringing a second surface 152 of the upper mounting unit 120 into engagement with a second planar surface 114 of the substrate 110 (e.g., an inner vertical surface 114 of flange 111) perpendicular to the first planar surface 112 of the substrate 110. In some examples, securing lower mounting unit 130 to upper mounting unit 120 as described causes the lower mounting unit 130 to engage with a third planar surface 116 of the substrate 110 that is opposed to the first planar surface 112 of the substrate.

As shown in the of 6A and 6B, connector 100 is configured to be secured in an aperture 113 formed in a substantially planar surface of the substrate 110, with a raised ridge 117 formed in the substrate 110. In other examples, substrate 110 may have not have such a raised ridge surrounding the aperture 113. According to these examples that incorporate a raised ridge 117, connector 100, including one or more of upper mounting unit 120 and lower mounting unit 130, may have a diameter that corresponds to a diameter of the raised ridge 117 in the substrate 110, such that lower mounting unit 130 sits within a depression formed by the ridge 117 in the third surface 116 of the substrate 110. Such embodiments may offer a connector 100 with further resilience to intended decoupling, in comparison with other connectors.

In the manner described, connector 100 engages with multiple surfaces of substrate 110, including perpendicular and opposed surfaces, to securely position electrical connection through aperture 113, which may offer advantages in comparison to other through-aperture electrical connectors. For example, connector 100 may be easier for an operator to securely lock within aperture 113 and/or may offer improved resilience to intended decoupling in comparison to other through-aperture connectors. For example, connector 100 may be easily installed without bolts to secure other through-aperture electrical connectors.

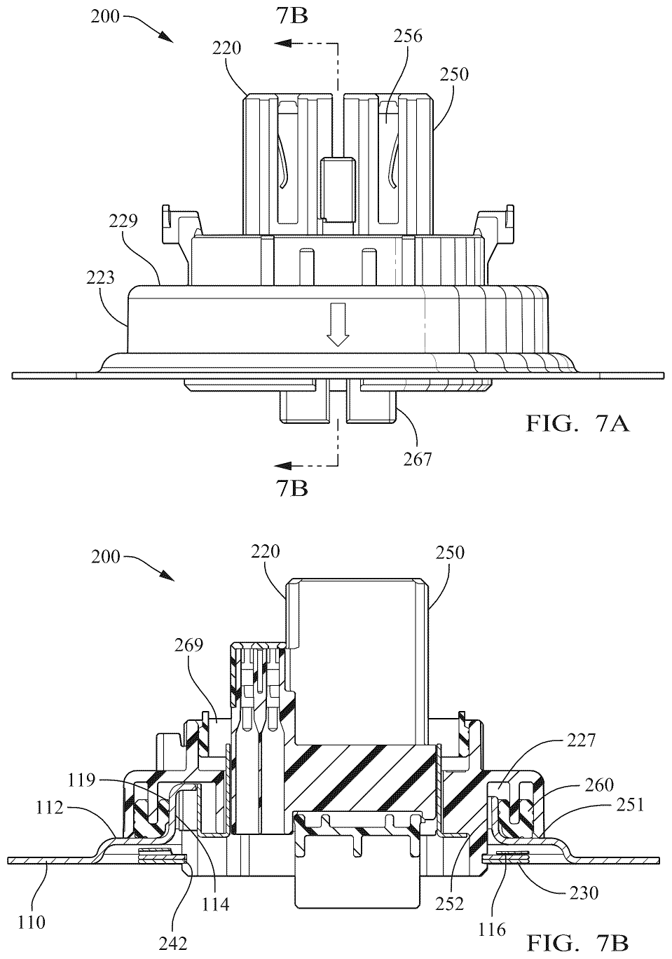

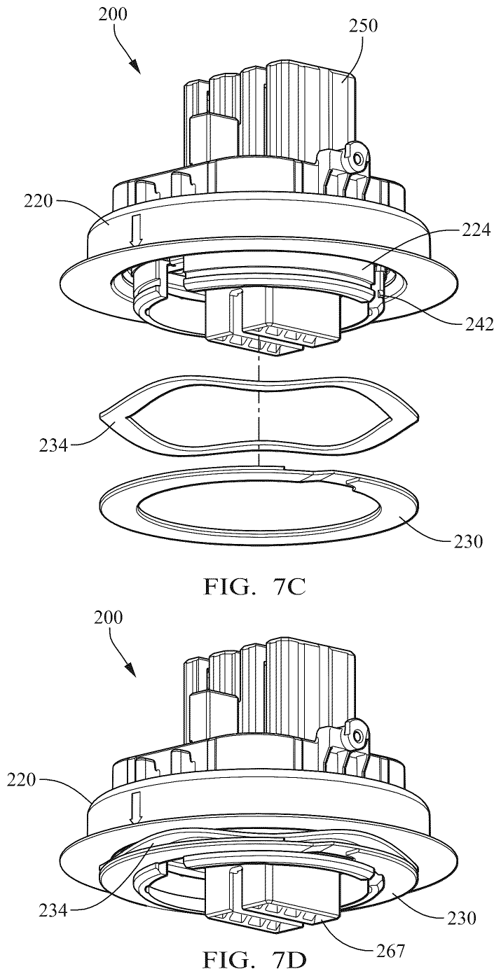

FIGS. 7A, 7B, 7C, and 7D depict side, isometric, and perspective views, respectively, of an electrical connector 200 according to some embodiments. Electrical connector 200 includes an upper mounting unit 220 that is substantially similar to upper mounting unit 120 described above, and includes a platform 229 supported by a rim 223 that presents towers 250 that support terminals 256 for electrical connection therewith. Also shown in FIG. 7A, upper mounting unit 220 further includes a lower connector 267 to support electrical connection from an underside of substrate 110. FIG. 7B is a cross-sectional view taken along the lines A-A shown in FIG. 7A, and depicts an example where upper mounting unit 220 is configured to accommodate an upper seal 269 to seal an interface between platform 229 and a mounted electrical connector (not shown).

Referring to FIG. 7B, upper mounting unit 220, like upper mounting unit 120 described above, includes a flange track 227 configured to accommodate a flange 111 to seat the upper mounting unit 220 in aperture 113. According to these embodiments, when seated in aperture 113, the upper mounting unit 220 includes a first surface 251 engaged with a first planar surface 112 of substrate 110, and a second surface 252 engaged with a second planar surface 114 of the substrate 110 substantially perpendicular to the first planar surface 112 of the substrate 110.

Connector 200 differs from connector 100 described above in that lower mounting unit 220 is a snap ring that interfaces with a corresponding track 242 defined on a surface of cylinder 224 to secure the upper and lower mounting units 220, 230 together within aperture 113 by engaging with a third planar surface 116 of the substrate 110, as shown in the example of FIGS. 7A, 7C, and 7D. According to some examples, connector 200 further comprises a continuous annular spring 234 between the lower mounting unit 220 and the third planer surface 116 of the substrate, which may operate to increase a retention force applied to third planar surface 116, and thereby a resiliency of connector 200 to unintended decoupling.

In order to couple connector 200 together within an aperture 113, and human or robot operator may arrange upper mounting unit 220 in a seated position within aperture 113 as described with respect to upper mounting unit 220 above. To secure connector 200 within aperture 113, a human or machine operator may, by manually or using a tool, place outward radial tension on mounting unit 230, and slide it over cylinder 224 (after spring 234) until it snaps into a secure position in track 242, opposed to the third planar surface 116 of substrate 110.

In the manner described, connector 200 engages with multiple surfaces of substrate 110, include perpendicular and opposed surfaces, to securely position electrical connection through aperture 113, which may offer advantages in comparison to other through-aperture electrical connectors. For example, connector 100 may be easier to install and/or more resilient to intended decoupling than other connectors. For example, connector 100 may be securely locked within aperture 113 without incorporating multiple bolts used to secure other through-aperture electrical connectors.

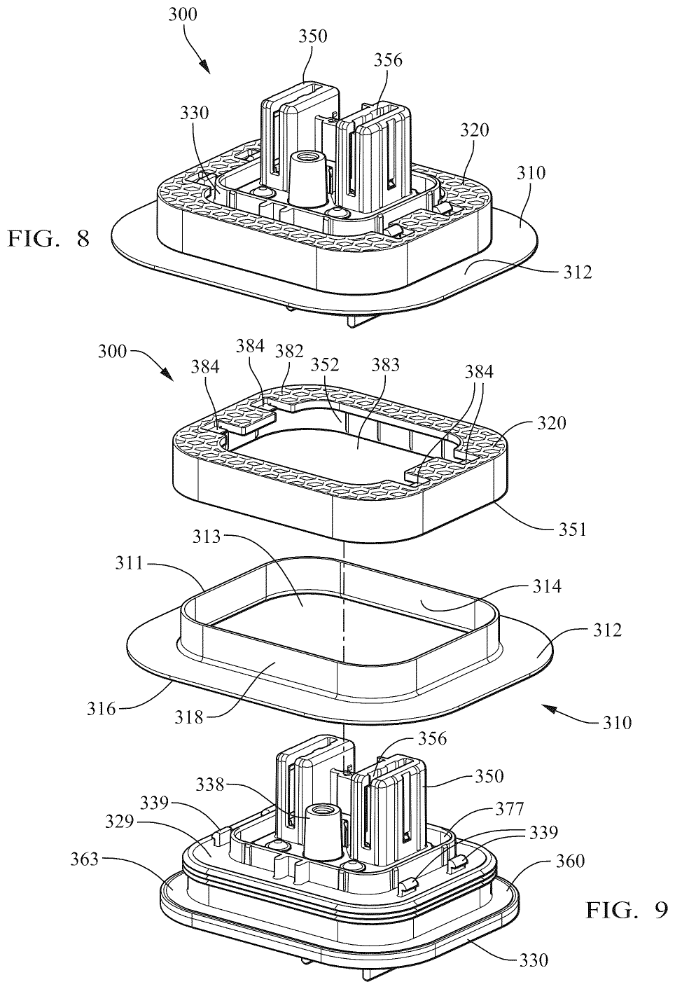

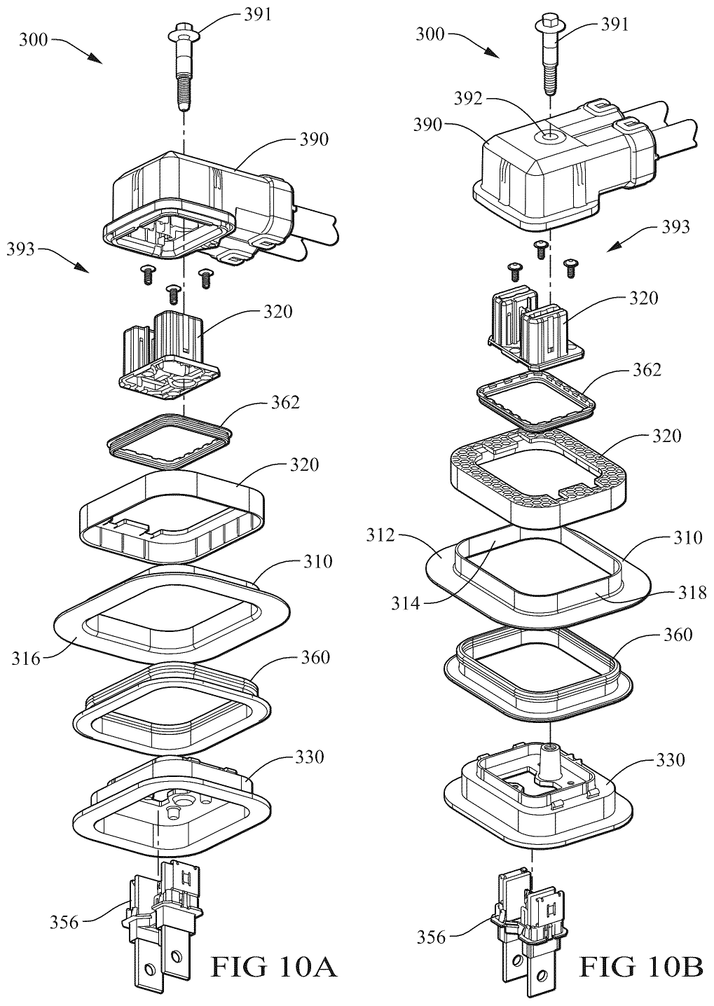

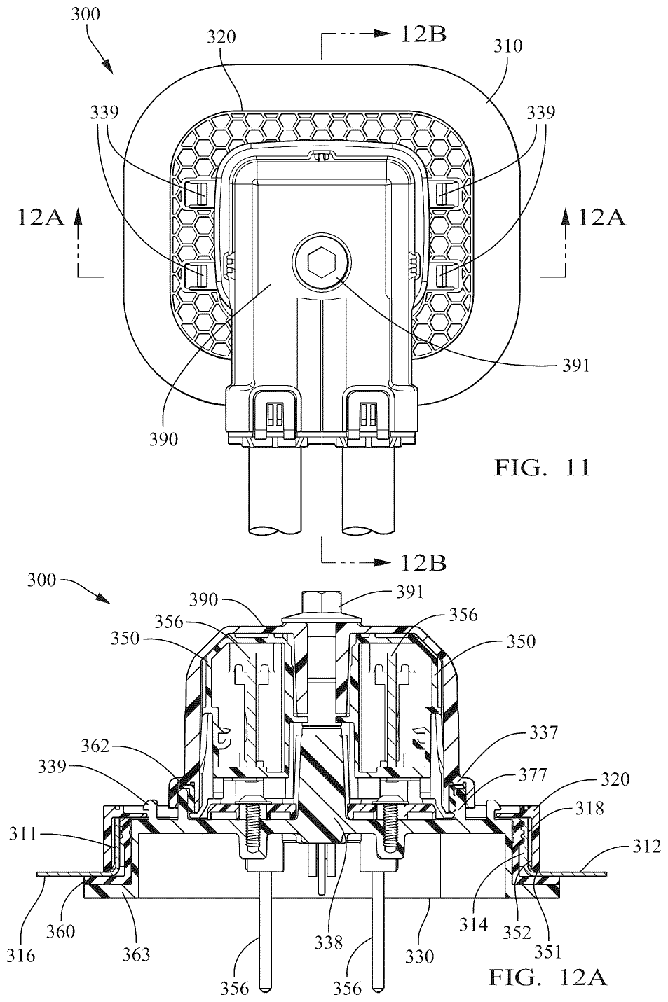

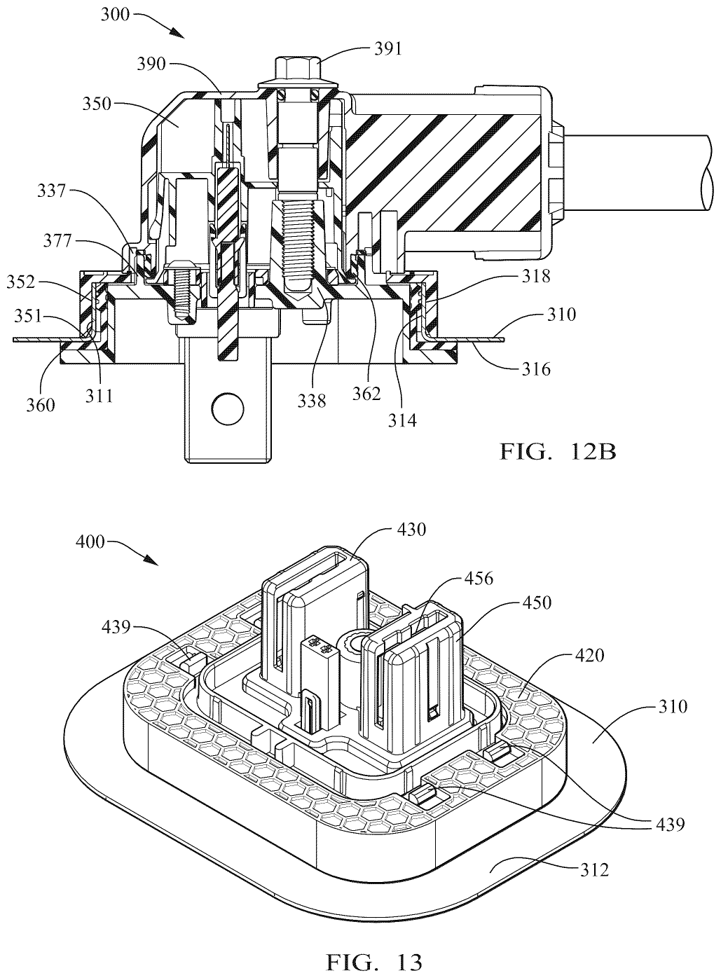

FIG. 8 depicts an isometric view of a through aperture electrical connector 300 according to some embodiments. FIG. 9 depicts an exploded view of some components of connector 300 according to some embodiments. FIGS. 10A and 10B depict alternate exploded views of connector 300 components according to some embodiments. FIG. 11. depicts a top-down view of connector 300 secured within an aperture 313 in a substrate 310. FIG. 12A depicts a cross-sectional view of connector 400, taken along the cut lines shown in FIG. 11. FIG. 12B depicts an alternative cross-section view of connector 400, taken along the cut lines shown in FIG. 11.

Connector 300 is configured to establish an electrical connection through an aperture 313 in a substrate 310. As shown in FIG. 9, substrate 300 includes a rectangular-shaped aperture 313 formed in a substrate 310, as one example, other aperture 313 shapes may be used. Substrate 310 further a flange 311 that surrounds the aperture 313. As shown in FIG. 9, substrate 310 includes a first planar surface 312 through which aperture 313 is formed, and a second planar surface 318 (an outer vertical surface of flange 311) arranged perpendicular to the first planar surface 312. As shown also shown in FIG. 9, substrate 310 includes a third planar surface 316 opposed to the first planar surface 312. As shown in FIG. 9, flange 311 further includes an inner vertical surface 314.

Substrate 310 may be, for example, a cover, a wall, or other surface of an enclosure configured to house one or more electrical components within the enclosure. For example, substrate 310 may be a surface of a battery box configured to house one or more components of a vehicle electrical system, such as one or more battery cells of the vehicle electrical system. Connector 300 may be configured to enable electrical connection from one side of the substrate 310 to another side of the substrate through the aperture 313, for example via an electrical terminal of a vehicle wiring harness to connector 300.

In some examples, substrate 310 may be formed of a suitable material to operate as an enclosure to house one or more vehicle electrical components, such as a metal or plastic substrate. In some examples, substrate 310 is part of a sheet metal enclosure that serves as an enclosure to house one or more battery or other components of a vehicle, such as an electric, hybrid, and/or gas-powered vehicle. In some examples, substrate 310 is formed of sheet metal around 1 mm thick.

Connector 300 is adapted to establish a secure electrical connection through aperture 313 by engaging with a plurality of respective planar surfaces of substrate 310, including flange 311. As shown in FIG. 9, connector 300 includes an upper mounting unit 320, and a lower mounting unit 330 that are coupleable to one another to secure connector 300 in aperture 313.

According to the example of FIG. 9, upper mounting unit 320 is a cover sized, shaped, and arranged to engage with a plurality of respective surfaces of substrate 310 to secure connector 300 within aperture 313. According to this example, upper mounting unit 320 includes an interior profile that substantially surrounds flange 311 and presents a raised platform 382 that presents tab features 384 configured to engage with corresponding tabs 339 presented on a platform 329 of the lower mounting unit 330, to hold the lower mounting unit 330 in position to be secured within the aperture 313. As shown in FIG. 9, the platform 382 includes an aperture 383 sized to accommodate towers 350 of lower mounting unit 330.

As also shown in FIG. 9, lower mounting unit 330 includes a ledge 363 that supports platform 329, that in turn supports towers 350 on the platform 329 that present terminals 356 for connection therewith. In the example of FIGS. 10A and 10B, towers 350 are formed of a component separate to platform 329, which and secured to platform 329 by a plurality of bolts 393 that correspond to apertures formed on the platform 329, although other mechanisms may be used to secure towers 350. As shown in FIG. 9, platform 329 defines an outer profile that corresponds to a size and shape of aperture 313, such that platform 329 can be inserted into aperture 313 from below substrate 310 by a human or machine operator.

To install connector 300 within aperture 313, the operator may first arrange upper mounting unit 320 in a seated position surrounding aperture 313 (e.g., surrounding flange 311). The operator then inserts lower mounting unit 330 through aperture 313 such that towers 350 extend through aperture 383 in the upper mounting unit 320 platform 382. The operator may push lower mounting unit 330 into upper mounting unit 320 until tabs 339 engage with tab features 384 on platform 382 and secure the upper and lower mounting units 320, 330 together, in a pre-staged position of the connector 300.

With tabs 339 engaged with tab features 384, an operator may seat connector housing 390 on the platform 329 in a staged position of connector 300. For example, referring to FIGS. 10A and 10B, the operator may arrange connector housing 390 such that flange track 337 aligns with flange 377 defined on platform 329. In some examples, a seal 362 may be arranged within the flange track 337, to seal an interface between the connector housing 390 and the platform 429.

As shown in FIGS. 10A and 10B, connector housing 390 includes a bolt aperture 392 that is aligned with a threaded post 338 on platform 329 when connector housing 390 is seated on platform 329. With connector 300 in the staged position with connector housing 390 seated on the platform 329, an operator may couple a bolt 391 to threaded post 338 through the bolt aperture 392 to lock connector 300 in place within aperture 313, as shown in FIGS. 9, 12A, and 12B. When connector 300 is locked in position in aperture 313, terminals 356 carried by towers 450 are electrically coupled with terminals 394 of connector housing 390 to establish an electrical connection within connector 300.

As shown in FIGS. 12A and 12B, when locked in aperture 313, connector 300 includes respective surfaces that engage with a plurality of surfaces of substrate 310 to secure connector 400 in the pre-staged position. For example, upper mounting unit 320 includes a first surface 351 that engages with a first planar surface 312 of substrate 310 (e.g., through which aperture 313 is formed). Upper mounting unit 320 further includes a second surface 352 that engages with a second planar surface 318 of the substrate 310. Lower mounting unit 330, via seal 360 supported by ledge 363, engages with a third planar surface 316 opposed to the first planar surface 312, to secure connector 300 in place within aperture 313. Seal 360 is arranged between lower mounting unit 330 and substrate 310, engaging planar surface 316 as a first sealing point, and an inner surface 314 of flange 311 as a second sealing point.

In manner described, connector 300 engages with multiple surfaces of substrate 310, include perpendicular and opposed surfaces, to securely establish an electrical connection through aperture 313, which may offer advantages in comparison to other through-aperture electrical connectors. For example, connector 300 may be advantageously resilient to unintended decoupling, and at the same time may be securely locked within aperture 313 with relative ease with only securing a single bolt, in contrast with other through-aperture electrical connectors that require multiple bolts used to secure other through-aperture electrical connectors.

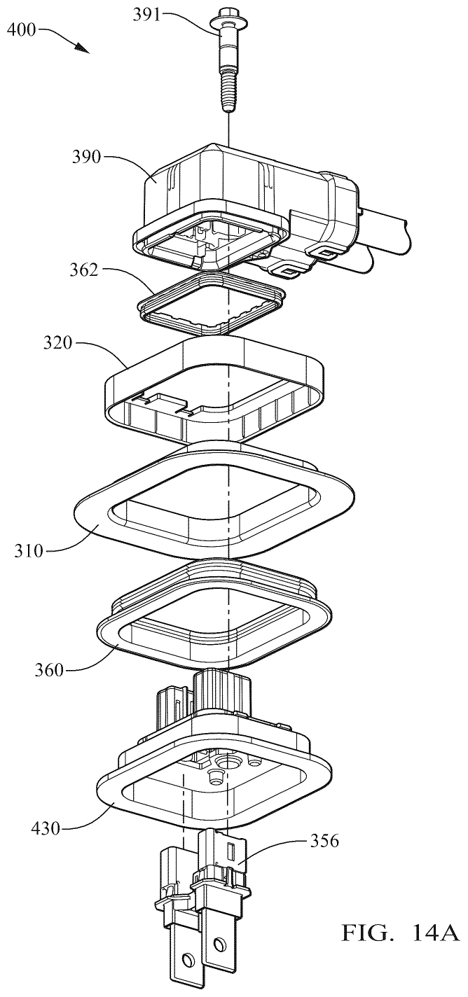

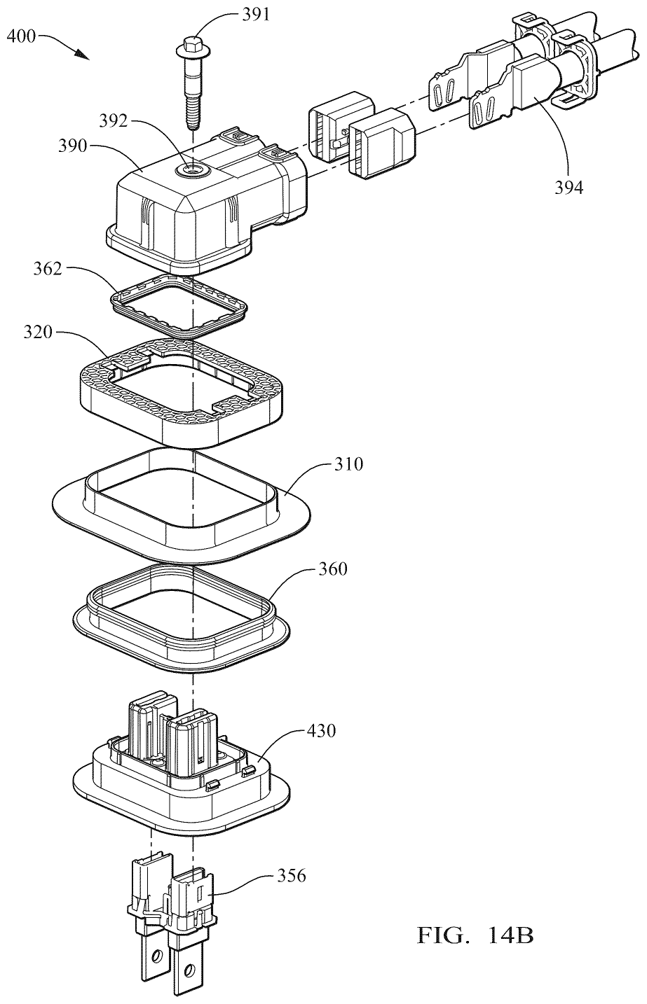

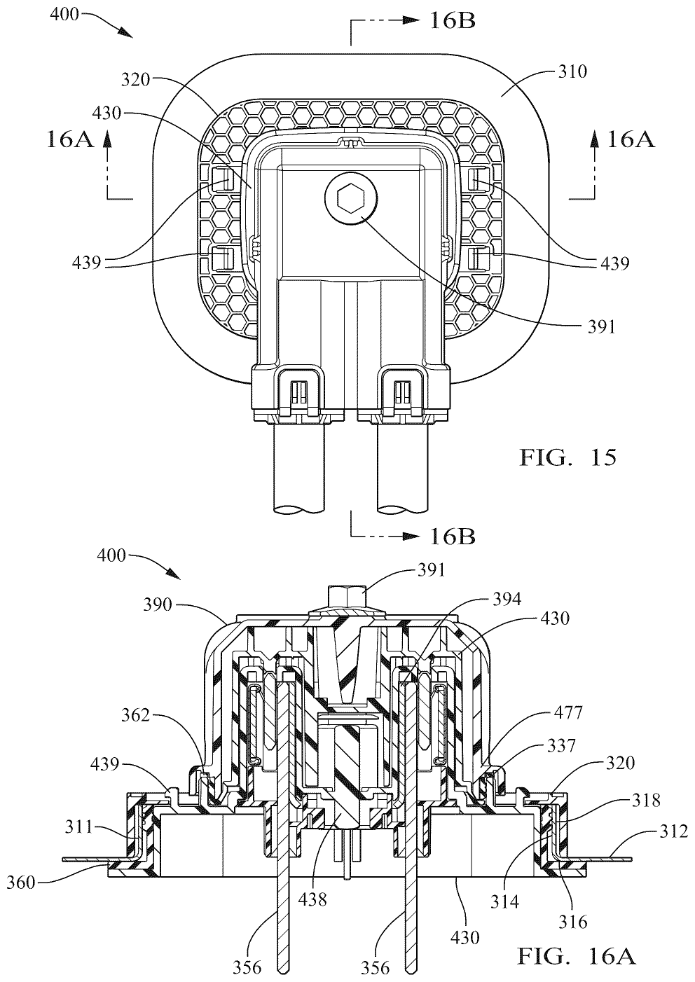

FIG. 13 is an isometric view of one example of an electrical connector 400 according to some embodiments. FIGS. 14A and 14B depict exploded views of connector 400 according to some embodiments. FIG. 15 depicts a top-down view of connector 400 secured within an aperture 313 in a substrate 310. FIG. 16A depicts a cross-sectional view of connector 400, taken along the cut lines shown in FIG. 15. FIG. 16B depicts an alternative cross-section view of connector 400, taken along the cut lines shown in FIG. 15.

Connector 400 is configured to establish an electrical connection through an aperture 313 in a substrate 310 which, as described above includes a rectangular-shaped aperture 313 formed in a substrate 310 as one example, other aperture 313 shapes may be used. Substrate 310 further includes a flange 311 that surrounds the aperture 313. As shown in FIG. 9, substrate 310 includes a first planar surface 312 through which aperture 313 is formed, and a second planar surface 318 (e.g., an outer vertical surface of flange 311), arranged perpendicular to the first planar surface 312. As shown also shown in FIG. 13, substrate 310 includes a third planar surface 316 opposed to the first planar surface 312. As shown in FIG. 9, flange 311 further includes an inner vertical surface 314.

Connector 400 is adapted to establish a secure electrical connection through aperture 313 by engages with a plurality of surfaces of substrate 310, including flange 311. As shown in FIG. 13, connector 400 includes an upper mounting unit 320 and a lower mounting unit 430 that are coupleable to one another to secure connector 400 in aperture 313.

Connector 400 differs from connector 300 depicted and described above with respect to FIG. 9 in that it includes a unitary lower mounting unit 430 with towers 450 integrated into a platform 429 a single piece, instead of being coupled together with bolts 393 as described above with reference to the exploded view of FIGS. 10A and 10B.

As also shown in FIG. 13, lower mounting unit 430 includes a ledge 463 that supports platform 429, that in turn supports towers 450 integrated into the platform 429 that present terminals 356 for connection therewith. As shown in FIG. 13, platform 429 defines an outer profile that corresponds to a size and shape of aperture 313, such that platform 429, integrated with towers 450, can be inserted into aperture 313 from below substrate 310 by a human or machine operator.

To install connector 400, a human or robotic operator may arrange upper mounting unit 320 in a seated position surrounding flange 111. The operator may then insert lower mounting unit 430 through aperture 313 such that towers 450 extend through aperture 383 in platform 382. The operator may push lower mounting unit 430 into upper mounting unit 320 until tabs 439 on platform 429 engage with tab features 384 on platform 382 and secure the upper and lower mounting units 320, 430 together, in a pre-staged position of the connector 400.

With tabs 439 engaged with tab features 384 in the pre-staged position, an operator may seat connector housing 390 on platform 429 in a staged position of connector 400. For example, referring to FIGS. 16A and 16B, the operator may arrange connector housing 390 such that flange track 337 aligns with flange 477 defined on platform 429. In some examples, a seal 362 may be arranged within the flange track 337, to seal an interface between the connector housing 390 and the platform 429.

As shown in FIGS. 14A and 14B, connector housing 390 includes a bolt aperture 392 that is aligned with a threaded post 438 on platform 429 when connector housing 390 is seated on platform 429. With connector housing 390 seated on the platform 429 in the staged position, an operator may couple a bolt 391 to threaded post 438 through the aperture 392 to lock connector 400 within aperture 313, as shown in FIGS. 13, 16A, and 16B. When connector 400 is locked in aperture 313, terminals 356 carried by towers 450 are electrically coupled with terminals 394 of connector housing 390 to establish an electrical connection within connector 400.

As shown in FIGS. 16A and 16B, when locked in aperture 313, connector 400 includes respective surfaces that engage with a plurality of surfaces of substrate 310 to secure connector 400 in the pre-staged position. For example, upper mounting unit 320 includes a first surface 351 that engages with a first planar surface 312 of substrate 310 (e.g., through which aperture 313 is formed). Upper mounting unit 320 further includes a second surface 352 that engages with a second planar surface 318 of the substrate 310. Lower mounting unit 430, via ledge 463, engages with a third planar surface 316 opposed to the first planar surface 312, to secure connector 400 in place within aperture 313. Seal 360 is arranged between lower mounting unit 430 and substrate 310, engaging planar surface 316 as a first sealing point, and an inner surface 314 of flange 311 as a second sealing point.

In the manner described, connector 400 engages with multiple surfaces of substrate 310, include perpendicular and opposed surfaces, to establish a secure electrical connection through aperture 313, which may offer advantages in comparison to other through-aperture electrical connectors. For example, connector 400 may be advantageously resilient to unintended decoupling, and at the same time may be securely locked within aperture 313 with relative ease with only securing a single bolt, in contrast with other through-aperture electrical connectors that require multiple bolts used to be secured in an aperture.

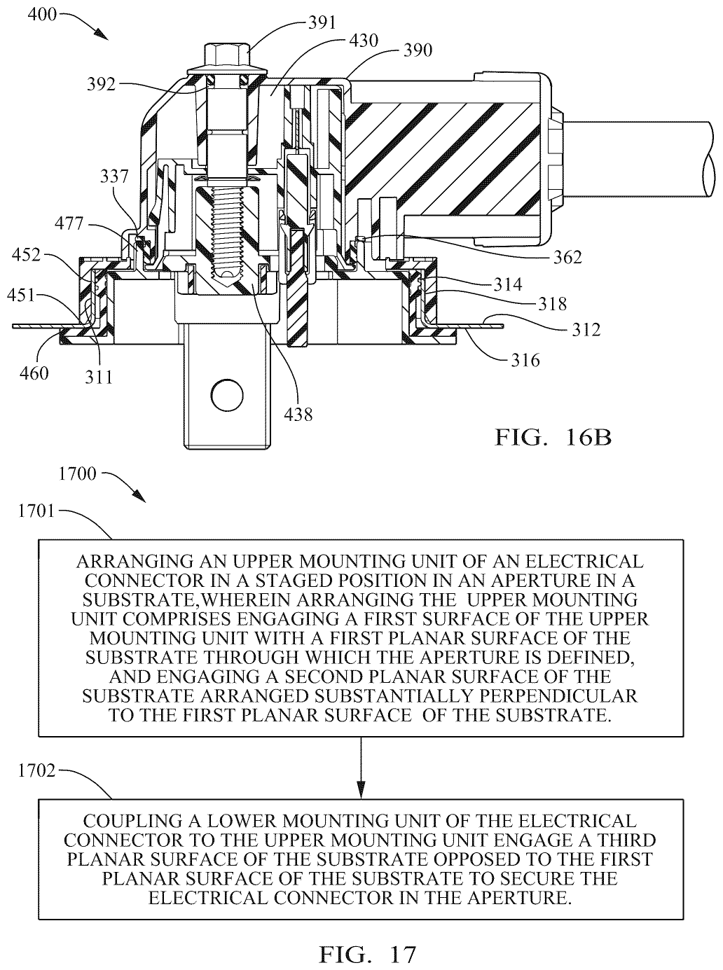

FIG. 17 is a flow diagram that depicts one example of a method 1700 according to one or more embodiments. As shown in FIG. 17, the method includes, at step 601, arranging an upper mounting unit (e.g., 120, 220, 320) of an electrical connector in a pre-staged position in an aperture (e.g., 113, 313) in a substrate (e.g., 110, 310), wherein arranging the upper mounting unit comprises engaging a first planar surface (e.g., 112, 312) of the substrate through which the aperture is defined, and engaging a second planar surface (e.g., 114, 314) of the substrate arranged substantially perpendicular to the first planar surface of the substrate. In some examples, a surface (e.g., 151, 251) of a rim (e.g., 123, 223) of the upper mounting unit engages the first planar surface of the substrate, and a second surface (e.g., 152, 252) a flange track (e.g., 127, 227) of the upper mounting unit engages the second planar surface of the substrate. In other examples, respective surfaces (e.g., 351, 352) of a cover (e.g., 320) engage the first and second planar surfaces of the substrate. In some examples, the second planar surface of the substrate comprises a flange (e.g., 111, 311) formed in the substrate.

As also shown in FIG. 17, at step 1702, the method further includes coupling a lower mounting unit (e.g., 130, 230, 330, 430) of the electrical connector to the upper mounting unit to engage a third planar surface (e.g., 116, 316) of the substrate to secure the electrical connector (e.g., 100) in the aperture. For example, the lower mounting unit (e.g., 130) may be a twist lock cap that engages with a cylinder (e.g., 124) of the upper mounting unit and engages with the third planar surface to secure the connector. In other examples, the lower mounting unit (e.g., 230) is a snap ring that engages with a cylinder (e.g., 224) of the upper mounting unit (e.g., 220) and engages with the third planar surface to secure the connector. In still other examples, the lower mounting unit (e.g., 330) includes a ledge (e.g., 363, 463) that engages with with the third planar surface of the substrate. In some examples, the lower mounting unit includes a platform (e.g., 329, 429) and tabs (e.g., 339, 439) that interfaces with corresponding tab features (e.g., 384) of the upper mounting unit to couple the upper and lower mounting units together in the aperture. In some such examples, the connector is secured by installing a bolt (e.g., 391) in a threaded post (e.g., 338, 438) of the upper mounting unit.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrical connector configured to establish an electrical connection through an aperture formed in a substrate comprising:
an upper mounting unit, comprising:
a first surface engaged with a first planar surface of the substrate through which the aperture is defined; and
a second surface different than the first surface engaged with a second planar surface of the substrate, wherein the second planar surface of the substrate is substantially perpendicular to the first planar surface of the substrate; and
a lower mounting unit configured to be coupled to the upper mounting unit and secured within the aperture via engaging with a third planar surface of the substrate, wherein the third planar surface of the substrate is opposed to the first planar surface of the substrate.

2. The electrical connector of claim 1, wherein the second planar surface of the substrate is a vertical surface of a flange formed in the first planar surface of the substrate.

3. The electrical connector of claim 2, wherein the upper mounting unit includes a track that receives the flange, and wherein the second surface of the upper mounting unit is a surface of the track in mechanical connection with the flange.

4. The electrical connector of claim 2, wherein the upper mounting unit further comprises a seal arranged between the upper mounting unit and the substrate, wherein the seal comprises at least a first sealing point between the seal and the flange, and at least a second sealing point between the seal and the first planar surface of the substrate.

5. The electrical connector of claim 2, wherein the upper mounting unit further comprises:
a shield contact arranged to contact the flange.

6. The electrical connector of claim 1, wherein the upper mounting unit comprises a platform supported by a rim, and wherein the first surface of the upper mounting unit comprises a surface of the rim.

7. The electrical connector of claim 2, wherein the upper mounting unit includes a cylinder configured to be arranged in the aperture.

8. The electrical connector of claim 7, wherein the cylinder includes a plurality of slots configured to receive a plurality of tabs of the flange.

9. The electrical connector of claim 7, wherein the lower mounting unit comprises a twist cap configured to be coupled to the cylinder.

10. The electrical connector of claim 7, wherein the lower mounting unit comprises a snap ring configured to be secured to the cylinder.

11. The electrical connector of claim 1, wherein the lower mounting unit comprises a platform supported by a rim, and wherein the first surface of the upper mounting unit comprises a surface of the rim.

12. The electrical connector of claim 1, wherein the lower mounting unit includes a ledge in mechanical connection with the third planar surface of the substrate.

13. The electrical connector of claim 12, wherein the upper mounting unit comprises tab features that interact with corresponding tabs on a platform of the lower mounting unit to couple the upper mounting unit and lower mounting unit together in the aperture.

14. The electrical connector of claim 12, further comprising a bolt that secures the upper mounting unit and the lower mounting unit together in the aperture via a threaded post on the lower mounting unit.

15. The electrical connector of claim 12, wherein the lower mounting unit includes towers coupled to the platform of the lower mounting unit.

16. The electrical connector of claim 15, wherein the towers and the platform are formed of a single unitary piece.

17. A method, comprising:
arranging an upper mounting unit of an electrical connector in a staged position in an aperture in a substrate, wherein arranging the upper mounting unit comprises engaging a first surface of the upper mounting unit with a first planar surface of the substrate through which the aperture is defined, and engaging a second planar surface of the substrate arranged substantially perpendicular to the first planar surface of the substrate;
coupling a lower mounting unit of the electrical connector to the upper mounting unit to engage a third surface of the substrate opposed to the first planar surface of the substrate to secure the electrical connector in the aperture.

18. The method of claim 17,
wherein coupling the lower mounting unit to the upper mounting unit comprises twisting the lower mounting unit onto a cylinder of the upper mounting unit.

19. The method of claim 18, wherein coupling the lower mounting unit to the upper mounting unit comprises securing a snap ring onto a cylinder of the upper mounting unit.

20. The method of claim 19, further comprising:
coupling the upper lower mounting unit and the lower mounting unit together in the aperture using a single bolt.
